(19) United States
(12) Patent Application Publication
(10) Pub. No.: US 2026/0201120 A1
(43) Pub. Date: Jul. 16, 2026

(54) ORGANOPOLYSILOXANE COMPOSITION WITH FILLER

(71) Applicant: Dow Silicones Corporation, Midland, MI (US)

(72) Inventors: Chi-Hao Chang, Midland, MI (US); Craig F. Graig, Midland, MI (US); Michael Hartmann, Nieder-Olm (DE); Patrick Beyer, Mainz (DE); Bizhong Zhu, Midland, MI (US); Hulusi Turgut, Midland, MI (US); Nathaniel P. Stelzer, Midland, MI (US)

(21) Appl. No.: 19/129,824

(22) PCT Filed: Nov. 30, 2023
(86) PCT No.: PCT/US2023/081850

§ 371 Date: May 14, 2025

Related U.S. Application Data
(60) Provisional application No. 63/428,271, filed on Nov. 28, 2022.

(51) Int. Cl. C08G 77/20; C08G 77/12; C08J 9/00; C08J 9/14; C08K 3/22; C08K 3/34; H01M 10/658; H01M 50/204

(52) U.S. Cl. CPC C08G 77/20; C08G 77/12; C08J 9/0066; C08J 9/142; C08K 3/22; C08K 3/34; H01M 10/658; H01M 50/204; C08J 2203/12; C08J 2203/182; C08J 2383/05; C08J 2383/07; C08K 2003/2227; C08K 2003/343

(57) ABSTRACT

The present invention relates to composition comprising a first polyorganosiloxane functionalized with a relatively high concentration of D^{H} groups; a second polyorganosiloxane functionalized with OH groups or ethylenically unsaturated groups; a blowing agent; filler; and a hydrosilylating catalyst. The composition of the present invention is useful for preparing a low-density high filler content foam, which is useful as a thermal barrier.

### BACKGROUND OF THE INVENTION

The present invention relates to an organopolysiloxane composition with relatively high filler content. The composition is useful as a precursor for a low-density high filler content foam for thermal barrier applications.

Polyorganosiloxane foams such as polydimethylsiloxane (PDMS) foams provide lower density and higher compressibility than corresponding rigid materials. PDMS foams containing fillers provide additional benefits such as flame retardancy, targeted (high or low) thermal conductivity, and more robust mechanical properties. Filler-containing foams may be used as a thermal barrier for rechargeable batteries, such as lithium-ion batteries (LiBs), which are commonly used in a variety of applications including electric vehicles (EVs). Although LiBs have the desirable performance of high energy density and cycling stability, safety concerns currently limit their usefulness. First, failure of an LiB cell can be triggered by a manufacturing defect, an internal short circuit, overheating, overcharging, or mechanical impact; second, the heat generated from the failing cell may propagate, thereby causing a thermal runaway in adjacent cells. The rapid pressure build-up arising from these thermal events increases the risks of fire and explosion.

Thermal events can be mitigated by placing a thermal barrier between cells in a battery module, which provides heat insulation and flame resistance. Commonly used thermal barriers such as aerogel, ceramic fiber, and mica board provide such properties; however, aerogel and ceramic fiber suffer poor mechanical resilience, while mica board is not compressible. On the other hand, although silicone blown foam provides adequate compressibility and, therefore, suitable for batteries of low and moderate energy density, it suffers from insufficient heat insulation to prevent thermal events for the very high energy density battery packs. The addition of filler particles to the foam would overcome this deficiency; nevertheless, the presence of fillers at useful levels disadvantageously increases the density of the foam.

It would therefore be advantageous in the field of thermal barriers to find a low-density insulating barrier with desired thermal properties, flame resistance, and other mechanical properties such as high modulus and greater mechanical strength.

### SUMMARY OF THE INVENTION

The present invention addresses a need in the art by providing, in one aspect, a composition comprising:
a) from 2 to 50 weight percent of a first polyorganosiloxane having degree of polymerization in the range of from 5 to 200 and a D^{H} concentration in the range of 60 to 100 mole percent;
b) from 10 to 90 weight percent of a second polyorganosiloxane functionalized with at least two groups which are either ethylenically unsaturated groups or OH groups or a combination thereof; and having a degree of polymerization in the range of from 50 to 2000;
wherein the concentrations of the first and the second polyorganosiloxanes are based on the weights of the first and the second polyorganosiloxanes;
c) from 0.1 to 20 weight percent of a blowing agent, which is a C₁-C₈-alcohol, C₁-C₈-diol, a benzyl alcohol, HO—(CH₂CHRO)_{z}—H, a polyorganosiloxane functionalized with at least one OH group and having a degree of polymerization in the range from 1 to 15, or water, based on the concentration of the first and the second polyorganosiloxanes and the blowing agent; where R is H, methyl, or ethyl, and z is from 2 to 5;
d) from 30 to 50 weight percent of one or more fillers, based on the weight of composition, wherein the one or more fillers are selected from the group consisting of metals, metal oxides, metal hydroxides, metal acetates, metal carbides, metal oxycarbides, metal carbonates and bicarbonates, metal hydroxycarbonates, metal sulfates, metal chlorides, metal nitrides, metal nitrates, metal silicides, metal silicates; and
e) a catalytic amount of a catalyst that promotes the reaction between the first and the second polyorganosiloxanes; and the first polyorganosiloxane and the blowing agent;
wherein the mole-to-mole ratio of D^{H} groups in the first polyorganosiloxane to the ethylenically unsaturated and/or OH groups of the second polyorganosiloxane is in the range of from 1.7:1 to 20:1.

The present invention addresses a need in the art by providing a way to prepare polyorganosiloxane foams with relatively low densities and relatively high filler content.

### BRIEF DESCRIPTION OF DRAWINGS

FIG. 1 is an illustration of a battery module containing polyorganosiloxane foam material.

### DETAILED DESCRIPTION OF THE INVENTION

In one aspect, the present invention is a composition comprising:
a) from 2 to 50 weight percent of a first polyorganosiloxane having degree of polymerization in the range of from 5 to 200 and a D^{H} concentration in the range of from 60 to 100 mole percent;
b) from 10 to 90 weight percent of a second polyorganosiloxane functionalized with at least two groups which are either ethylenically unsaturated groups or OH groups or a combination thereof; and having a degree of polymerization in the range of from 50 to 2000;
wherein the concentrations of the first and the second polyorganosiloxanes are based on the weights of the first and the second polyorganosiloxanes;
c) from 0.1 to 20 weight percent of a blowing agent, which is a C₁-C₈-alcohol, C₁-C₈-diol, a benzyl alcohol, HO—(CH₂CHRO)_{z}—H, a polyorganosiloxane functionalized with at least one OH group and having a degree of polymerization in the range from 1 to 15, or water, based on the concentration of the first and the second polyorganosiloxanes and the blowing agent; where R is H, methyl, or ethyl, and z is from 2 to 5;
d) from 30 to 50 weight percent of one or more fillers, based on the weight of composition, wherein the one or more fillers are selected from the group consisting of metals, metal oxides, metal hydroxides, metal acetates, metal carbides, metal oxycarbides, metal carbonates and bicarbonates, metal hydroxycarbonates, metal sulfates, metal chlorides, metal nitrides, metal nitrates, metal silicides, and metal silicates; and
e) a catalytic amount of a catalyst that promotes the reaction between the first and the second polyorganosiloxanes; and the first polyorganosiloxane and the blowing agent;
wherein the mole-to-mole ratio of D^{H} groups in the first polyorganosiloxane to the ethylenically unsaturated and/or OH groups of the second polyorganosiloxane is in the range of from 1.7:1 to 20:1.

The first polyorganosiloxane is illustrated by structure 1:

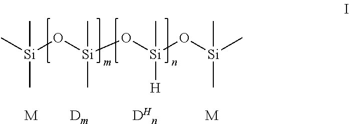

where m is from 0 to 80 and n is from 5 to 200 or to 100, with the proviso that the ratio of m:n is in the range of from 0:100 to 40:60, preferably to 36:64. Accordingly, the D^{H} concentration is in the range of from 60 or from 64 mole percent to 100 mole percent. It is understood that the first polyorganosiloxane may be one or more polyorganosiloxanes with a weighted average D^{H} concentration in the range of from 60 or from 64 mole percent to 100 mole percent. It is further understood that the D and D^{H} groups are distributed in a random, block, or alternating manner.

The second polyorganosiloxane is at least one polyorganosiloxane functionalized with one or more OH groups or one or more ethylenically unsaturated groups or a combination of OH and ethylenically unsaturated groups. Preferably, the degree of polymerization of the second polyorganosiloxane is in the range of from 100 to 1000.

The second polyorganosiloxane may further comprise a polyorganosiloxane resin functionalized with one or more OH groups or one or more ethylenically unsaturated groups or a combination of OH and ethylenically unsaturated groups. The polyorganosiloxane resin comprises SiO_{3/2} units or SiO_{4/2} units or both, as illustrated:

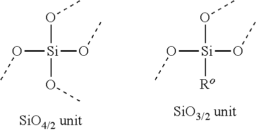

where R^{o} is methyl, ethyl, or phenyl, and the dashed lines represent the points of attachment to other groups. Examples of preferred second polyorganosiloxanes include divinylpolydimethylsiloxanes, and vinyl-substituted polyorganosiloxane resins, and dihydroxypolydimethylsiloxane resins, and combinations thereof. The catalyst is preferably a platinum-based catalyst such as chloroplatinic acid and is used in a catalytic amount, typically in the range of from 0.5 ppm to 200 ppm of Pt, based on the weight of the composition.

The mole-to-mole ratio of D^{H} groups in the first polyorganosiloxane to hydroxyl and/or ethylenically unsaturated groups in the second polyorganosiloxane is in the range of from 1.7:1 or from 1.9:1 or from 3:1 or from 5:1, to 20:1 or to 15:1 or to 10:1. Preferably, the second polyorganosiloxane comprises ethylenically unsaturated groups, more preferably two vinyl groups.

The blowing agent reacts with Si—H groups in the presence of a Pt catalyst to generate H₂ gas. Accordingly, the blowing agent may be a C₁-C₈-alcohol, C₁-C₈-diol, a benzyl alcohol, HO—(CH₂CHRO)_{z}—H, where R is H, methyl, or ethyl, and z is from 2 to 5; or water. Examples of blowing agents include benzyl alcohol, ethanol, propanol, and 1,4-butanediol.

The fillers are metals, metal oxides, metal hydroxides, metal acetates, metal carbides, metal oxycarbides, metal carbonates and bicarbonates, metal hydroxycarbonates, metal sulfates, metal chlorides, metal nitrides, metal nitrates, metal silicides, metal silicates, as well as hydrates thereof, and mixtures thereof. The fillers are in the form of particles having a mean volume particle size typically in the range of from 0.1 μm or from 0.5 μm or from 1 μm, to 1000 μm or to 500 μm or to 200 μm or to 100 μm or to 50 μm, as determined using a dynamic light scattering analyzer such as a Beckman Coulter LS 130 Particle Size Analyzer.

Examples of suitable fillers include aluminum trihydroxide, hydromagnesite, epsomite, nesquihonite, boehmite, huntite, magnesium hydroxides, silicas, ground quartz, alumina, calcium sulfate, copper acetate, magnesium chloride, sodium sulfate, aluminosilicates, boron nitride, aluminum nitride, micas, wollastonite, calcium silicates, basalt, clays including calcined clays, zeolites, hollow fillers such as hollow glass spheres and hollow ceramics, expanded perlite, calcium carbonate, cerium oxide, iron oxides, titanium oxide, zinc oxide, and glass fibers, as well as hydrates of these fillers.

It may be desirable to use high loadings of a combination of fillers to achieve desired properties such as improved fire resistance and mechanical strength at high temperatures. A particularly desirable combination of fillers is aluminum trihydroxide and wollastonite. The concentration of filler, based on the weight of the composition is in the range of from 30, preferably from 35, to 50, preferably to 45 weight percent.

The composition is advantageously prepared in a two-part system. More particularly, the Pt catalyst is separated from the first polyorganosiloxane to prevent premature reaction of the first polyorganosiloxane with the second polyorganosiloxane and the blowing agent. In one preferred method of preparing the composition of the present invention, a first portion of the second polyorganosiloxane, the Pt catalyst, and the blowing agent are mixed in a first chamber. Then a first portion of the filler is added to contents of the first chamber with further mixing. In a second vessel, the first polyorganosiloxane is mixed with a second portion of the second polyorganosiloxane followed by addition and further mixing of a second portion of the filler. Filler is advantageously included in each chamber to enhance mixing of the two parts. The two parts are each dispensed through a dispenser, which is typically a dual-pack cartridge equipped with a static mixer, then to the desired substrate or into the targeted area. Reaction and concomitant foaming arising from the release of hydrogen begin after the first polyorganosiloxane contacts the second polyorganosiloxane and the blowing agent. The foam is advantageously cured at advanced temperatures, preferably at least 80° C. or at least 100° C., and preferably up to 200° C. or up to 150° C.

The resulting foam contains remnants of a blowing agent and remnants of the second polyorganosiloxane. A remnant of the blowing agent is the product of the reaction of an Si—H group from the first polyorganosiloxane and one or more OH groups of the blowing agent:

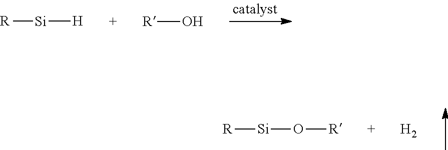

where R—Si—H is the first organopolysiloxane, R′—OH is the blowing agent, and O—R′ is the remnant of the blowing agent.

Similarly, a remnant of the second polyorganosiloxane is the product of the reaction of an Si—H group from the first polyorganosiloxane and the OH and/or ethylenically unsaturated groups of the second polyorganosiloxane. When the second polyorganosiloxane contains two ethylenically unsaturated groups, the remnant from the following reaction:

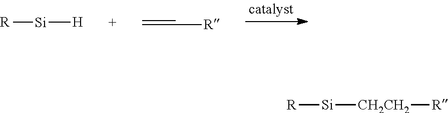

wherein ═—R″—Si is the second polyorganosiloxane and CH₂CH₂—R″ is the remnant of the second polyorganosiloxane.

The foam arising from the composition of the present invention has surprisingly been found to have high filler loadings (30 to 50 weight percent) and a foam density in the range of from 0.20 g/cm³, or from 0.25 g/cm³ to 0.60 g/cm³ or to 0.52 g/cm³ or to 0.40 g/cm³. Accordingly, in another aspect, the present invention is a polyorganosiloxane foam interspersed with from 30 to 50 weight percent filler particles, based on the weight of the foam and the filler particles, wherein the foam is further characterized by containing i) structural units of an Si—H group and a blowing agent; and ii) structural units of an Si—H groups and an OH group and/or an ethylenically unsaturated group, wherein the ratio of i:ii is in the range of from 1.7:1 to 20:1 or to 15:1.

The foam is useful as a barrier material for battery module applications. In another aspect, the present invention is a battery module comprising a shell containing an array of spatially separated battery cells and the composition of the present invention contacting adjacent battery cells.

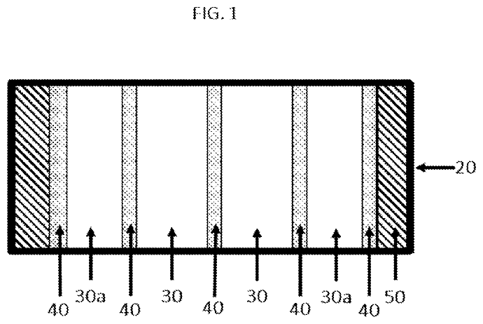

FIG. 1 represents this embodiment of the present invention. A battery module comprises a shell (20) housing an array of spatially separated battery cells (30 and 30a) and barrier material (40) contacting adjacent battery cells, thereby creating an insulating barrier between battery cells (30 and 30a). In this embodiment, the barrier material is positioned between adjacent battery cells (30 and 30a); in another embodiment, the barrier material covers the battery cells. The battery module may further comprise end plates (50) at the internal edges of the shell that are in direct contact with battery cells (not shown) or indirect contact with battery cells (30a) through the barrier material (40). The barrier material can be inserted into the spaces between adjacent battery cells and between the cells and end plates; alternatively, a foam precursor can be applied onto the cells and into the spaces between battery cells, then cured to form the barrier material. Examples of suitable battery cell designs include cylindrical, pouch, and prismatic cells.

### EXAMPLES

In the following examples, pbw refers to parts by weight. All components were mixed using a Flacktex Speed Mixer at 2000 rpm.

### Comparative Intermediate Example 1—Preparation of a 2-Part Composition without Filler

A first component (Part A) was prepared by mixing in a 64:36 w/w blend of 1) a dimethylvinylsiloxy-terminated polydimethylsiloxane, having a viscosity of ~1,900 mPa·s, 0.22 wt. % vinyl groups; and 2) a ViMe₂SiO_{1/2}/(CH₃)₃Si—O_{1/2}/SiO_{4/2} resin, having a ViMe₂SiO_{1/2}:(CH₃)₃Si—O_{1/2}:SiO_{4/2} structural unit ratio of 5:40:55, a M. of 5000 and a M_{w} of 21,400 (Polymer-Resin Blend, 78.11 pbw); and b) a dimethylvinylsiloxy end-capped polydimethylsiloxane having a viscosity of 40,000 mPa·s (Polymer 1, 13.63 pbw) for 30 s. A complex of Pt(0) and divinyltetramethyldisiloxane (1.13 pbw, 0.62 pbw Pt), 1,4-butanediol (3.14 pbw), and benzyl alcohol (4 pbw) were added to the mixture, and mixing was continued for an additional 30 s.

A second component (Part B) was prepared by mixing Polymer-Resin Blend (64.36 pbw) and Polymer 1 (11.23 pbw) for 30 s. A linear organohydrogenpolysiloxane of MD^{H}_{79.31}M (Polymer 2, 17.95 pbw), and a polydimethylorganohydrogensiloxane of MD_{3.2}D^{H}_{5.8}M (Polymer 3, 6.46 pbw) were added to the mixture and mixing was continued for an additional 30 s.

### Comparative Intermediate Example 2—Preparation of a 2-Part Composition with Filler and Si—H:Vinyl Ratio of 6.23:1 and D^{H} Mole Percent of 31.8%

A first component (Part A) was prepared by mixing Polymer-Resin Blend (46.06 pbw), Polymer 1 (8.04 pbw), and Micral 855 aluminum hydroxide (10.8 pbw) for 30 s. A complex of Pt(0) and divinyltetramethyldisiloxane (0.66 wt. %, 0.62 wt % Pt), 1,4-butanediol (1.85 pbw), and benzyl alcohol (2.36 pbw) were then added to the mixture and mixing was continued for 30 s. Imerys Nyad G Wollastonite (30.23 pbw) was added to the mixture and mixing was continued for an additional 30 s.

Part B was prepared by mixing Polymer Resin Blend (20.11 pbw), Polymer 1 (3.51 pbw), and Hymod M855 aluminum hydroxide (10.41 pbw) for 30 s, then adding Polymer 3 (2.02 pbw) and a linear organohydrogenpolysiloxane of MD_{8.7}D^{H}_{3.7}M (Polymer 4, 33.72 pbw). Mixing was continued for 30 s, after which time Imerys Nyad G Wollastonite (30.23 pbw) was added to the mixture and mixing was continued for an additional 30 s.

### Comparative Intermediate Example 3—Preparation of a 2-Part Composition with Filler and Si—H:Vinyl Ratio of 1.48:1 and D^{H} of 21.5%

A first component (Part A) was prepared by mixing Polymer-Resin Blend (18.75 pbw) and a dimethylvinylsiloxy end-capped polydimethylsiloxane having a viscosity of ~2,200 mPa·s (Polymer 5, 50.9 pbw) for 30 s. A complex of Pt(0) and divinyltetramethyldisiloxane (0.64 pbw, 0.62 pbw Pt) and benzyl alcohol (7.72 pbw) were added to the mixture. The contents were mixed at for 30 s, after which time Imerys Nyad G Wollastonite (14.39 pbw) and Minusil 5 Silica (5 μm, 7.6 pbw) were added to the mixture and mixing was continued for an additional 30 s.

Part B was prepared by mixing Polymer Resin Blend (18.75 pbw) and Polymer 5 (47.58 pbw) for 30 s. Polymer 4 (6.68 pbw) and a linear organohydrogenpolysiloxane of MD₆₀D^{H}₇M (Polymer 6, 5 pbw), and were added to the mixture and the contents were mixed at 2000 rpm for 30 s. Then, Imerys Nyad G Wollastonite (14.39 pbw) and Minusil 5 Silica (5 μm, 7.6 pbw) were added to the mixture and mixing was continued for an additional 30 s.

### Intermediate Example 1—Preparation of a 2-Part Composition with Filler and Si—H:Vinyl Ratio of 1.94:1 and D^{H} of 90.6%

A first component (Part A) was prepared by mixing Polymer-Resin Blend (45.53 pbw), Polymer 1 (7.94 pbw), and Micral 855 aluminum hydroxide (10.68 pbw) for 30 s. A complex of Pt(0) and divinyltetramethyldisiloxane (0.66 pbw, 0.62 pbw Pt), 1,4-butanediol (1.82 pbw), and benzyl alcohol (2.33 pbw) were then added to the mixture and mixing was continued for 30 s. Imerys Nyad G Wollastonite (31.03 pbw) was added to the mixture and mixing was continued for an additional 30 s.

A second composition (Part B) was prepared by mixing Polymer-Resin Blend (48.27 pbw), Polymer 1 (3.91 pbw), and Hymod M855 aluminum hydroxide (11.59 pbw) for 30 s. Polymer 2 (2.93 pbw) and Polymer 3 (2.25 pbw) were then added to the mixture, and the contents mixed for 30 s. Imerys Nyad G Wollastonite (31.03 pbw) was added to the mixture and mixing was continued for an additional 30 s.

Table 1 is a summary of the Part A and Part B formulations in pbw. PRB refers to Polymer-Resin Blend; P1-P6 refer to Polymers 1-6; BDO refers to 1,4-butane diol; BzOH refers to benzyl alcohol; Pt refers to the Pt(0) complex; F1 refers to Micral 855 ATH Filler; F2 refers to Hymod M855-SP Filler; F3 refers to Nyad G Wollastonite Filler; and F4 refers to Minusil 5 Silica.

TABLE 1
Part A and Part B Formulations

| | | | |
|---|---|---|---|
| C1 | C2 | C3 | Ex. 1 |

| Comp. | A | B | A | B | A | B | A | B |
|---|---|---|---|---|---|---|---|---|
| PRB | 78.11 | 64.36 | 46.06 | 20.11 | 18.75 | 18.75 | 45.53 | 48.27 |
| P1 | 13.63 | 11.23 | 8.04 | 3.51 | 0 | 0 | 7.94 | 3.91 |
| P2 | 0 | 17.95 | 0 | 0 | 0 | 0 | 0 | 2.93 |
| P3 | 0 | 6.46 | 0 | 2.02 | 0 | 6.68 | 0 | 2.25 |
| P4 | 0 | 0 | 0 | 33.72 | 0 | 0 | 0 | 0 |
| P5 | 0 | 0 | 0 | 0 | 50.90 | 47.58 | 0 | 0 |
| P6 | 0 | 0 | 0 | 0 | 0 | 5.00 | 0 | 0 |
| BDO | 3.14 | 0 | 1.85 | 0 | 0 | 0 | 1.83 | 0 |
| BzOH | 4.00 | 0 | 2.36 | 0 | 7.72 | 0 | 2.33 | 0 |
| Pt | 1.13 | 0 | 0.66 | 0 | 0.64 | 0 | 0.66 | 0 |
| F1 | 0 | 0 | 10.8 | 0 | 0 | 0 | 10.68 | 0 |
| F2 | 0 | 0 | 0 | 10.41 | 0 | 0 | 0 | 11.59 |
| F3 | 0 | 0 | 30.23 | 30.23 | 14.39 | 14.39 | 31.03 | 31.03 |
| F4 | 0 | 0 | 0 | 0 | 7.6 | 7.6 | 0 | 0 |

Table 2 illustrates additional Part A and Part B formulations used to prepare the compositions of the present invention. F5 refers to Mica WG-325 Muscovite mica.

TABLE 2
Part A and B Formulations

| | Ex. 2 | | Ex. 3 | | Ex. 4 | | Ex. 5 | | Ex. 6 | |
|---|---|---|---|---|---|---|---|---|---|---|
| Comp. | A | B | A | B | A | B | A | B | A | B |
| PRB | 46.06 | 25.9 | 45.53 | 33.63 | 46.06 | 23.88 | 46.06 | 33.69 | 46.06 | 33.69 |
| P1 | 8.04 | 4.52 | 7.94 | 5.87 | 8.04 | 4.17 | 8.04 | 5.88 | 8.04 | 5.88 |
| P2 | 0 | 23.35 | 0 | 12.07 | 0 | 0 | 0 | 9.40 | 0 | 9.40 |
| P3 | 0 | 2.60 | 0 | 0 | 0 | 29.37 | 0 | 3.38 | 0 | 3.38 |
| P4 | 0 | 0 | 0 | 0 | 0 | 0 | 0 | 0 | 0 | 0 |
| P5 | 0 | 0 | 0 | 0 | 0 | 0 | 0 | 0 | 0 | 0 |
| P6 | 0 | 0 | 0 | 0 | 0 | 0 | 0 | 0 | 0 | 0 |
| BDO | 1.85 | 0 | 1.83 | 0 | 1.85 | 0 | 1.85 | 0 | 1.85 | 0 |
| BzOH | 2.36 | 0 | 2.33 | 0 | 2.36 | 0 | 2.36 | 0 | 2.36 | 0 |
| Pt | 0.66 | 0 | 0.66 | 0 | 0.66 | 0 | 0.66 | 0 | 0.66 | 0 |
| F1 | 10.8 | 0 | 10.68 | 0 | 10.80 | 0 | 10.8 | 0 | 10.8 | 0 |
| F2 | 0 | 13.4 | 0 | 17.4 | | 12.35 | 0 | 17.43 | 0 | 17.43 |
| F3 | 30.23 | 30.23 | 31.03 | 31.03 | 30.23 | 30.23 | 30.23 | 30.23 | 0 | 0 |
| F5 | 0 | 0 | 0 | 0 | 0 | 0 | 0 | 0 | 30.23 | 30.23 |

### Fabrication of Foam Sheets

All foams sheets were fabricated using the following procedure. Parts A and B were fully mixed for 15 s. The mixture was then poured between two matte mylar film sheets. The initial (before foaming) thickness was controlled at 0.045″ using a nip roller. The sample was then transferred to an oven set to 120° C. After 2 min, the release film sheets were removed, and the sample was continuously cured at 120° C. Foam density was calculated based on the average thickness and weight of two foam samples with a diameter of 1 inch (2.54 cm).

Table 3 illustrates the calculated D^{H} mole percent (D^{H} %=D^{H}ₘ/(D^{H}ₘ+Dₙ), the ratio of D^{H} groups to vinyl groups (D^{H}:vinyl) for blends of Parts A and B upon mixing, the filler concentration (Filler %), the foam density in g/cm³ (Density), and uniformity of foam (Foam). U refers to a uniform foam and NU refers to a non-uniform foam.

TABLE 3
D^{H} mole percent and D^{H}:vinyl Ratios

| Ex. No. | D^{H} % | D^{H}:vinyl | Filler % | Density | Foam |
|---|---|---|---|---|---|
| C1 | 90.6 | 6.13 | 0 | 0.15 | NU |
| C2 | 31.8 | 6.23 | 40.83 | 1.04 | U |
| C3 | 21.5 | 1.48 | 21.99 | 1.03 | U |
| Ex. 1 | 84.6 | 1.94 | 42.17 | 0.52 | U |
| Ex. 2 | 96.4 | 14.93 | 42.33 | 0.39 | U |
| Ex. 3 | 100 | 6.61 | 45.07 | 0.31 | U |
| Ex. 4 | 64.4 | 10.00 | 41.81 | 0.48 | U |
| Ex. 5 | 90.6 | 6.13 | 44.34 | 0.27 | U |
| Ex. 6 | 90.6 | 6.13 | 44.34 | 0.49 | U |

Table 3 demonstrates that foams with a density of <0.6 g/cm³ and a filler concentration above 30% can be achieved from polyorganosiloxane compositions by adjusting D^{H}:vinyl group ratios and D^{H} concentrations. The data also suggest that low density high filler concentration foams are achievable with a variety of filler materials. It has also surprisingly been discovered that the foam that contained no filler (C1) was non-uniform resulting in poor thickness control and poor compressibility.

The relatively high ratio Si—H groups to vinyl groups or SiOH groups, coupled with a relatively high concentration of Si—H groups in the first polyorganosiloxane results in higher production of H₂ gas, therefore providing greater expansion, therefore reduced foam density, with concomitant reduced crosslinking density. Surprisingly, the high concentration of filler aids in the production of a uniform foam despite higher H₂ gas production.

1. A composition comprising:
a) from 2 to 50 weight percent of a first polyorganosiloxane having degree of polymerization in the range of from 5 to 200 and a D^{H} concentration in the range of 60 to 100 mole percent;
b) from 10 to 90 weight percent of a second polyorganosiloxane functionalized with at least two groups which are either ethylenically unsaturated groups or OH groups or a combination thereof; and having a degree of polymerization in the range of from 50 to 2000;
wherein the concentrations of the first and the second polyorganosiloxanes are based on the weights of the first and the second polyorganosiloxanes;
c) from 0.1 to 20 weight percent of a blowing agent, which is a C₁-C₈-alcohol, C₁-C₈-diol, a benzyl alcohol, HO—(CH₂CHRO)_{z}—H, a polyorganosiloxane functionalized with at least one OH group and having a degree of polymerization in the range from 1 to 15, or water, based on the concentration of the first and the second polyorganosiloxanes and the blowing agent; where R is H, methyl, or ethyl, and z is from 2 to 5;
d) from 30 to 50 weight percent of one or more fillers, based on the weight of composition, wherein the one or more fillers are selected from the group consisting of metals, metal oxides, metal hydroxides, metal acetates, metal carbides, metal oxycarbides, metal carbonates and bicarbonates, metal hydroxycarbonates, metal sulfates, metal chlorides, metal nitrides, metal nitrates, metal silicides, metal silicates; and
e) a catalytic amount of a catalyst that promotes the reaction between the first and the second polyorganosiloxanes; and the first polyorganosiloxane and the blowing agent;
wherein the mole-to-mole ratio of D^{H} groups in the first polyorganosiloxane to the ethylenically unsaturated and/or OH groups of the second polyorganosiloxane is in the range of from 1.7:1 to 20:1.

2. The composition of claim 1 wherein a first polyorganosiloxane has a degree of polymerization in the range of from 5 to 100 and a D^{H} concentration in the range of 64 to 100 mole percent; and the mole-to-mole ratio of D^{H} groups in the first polyorganosiloxane to the ethylenically unsaturated groups and/or OH groups in the second polyorganosiloxane is in the range of from 1.7:1 to 15:1.

3. The composition of claim 2 wherein the second polyorganosiloxane is one or more polyorganosiloxanes functionalized with two ethylenically unsaturated groups.

4. The composition of claim 3 wherein the ethylenically unsaturated groups are vinyl groups; wherein the blowing agent is C₁-C₈-alcohol, a C₁-C₈-diol, or benzyl alcohol or a combination thereof; and wherein the filler is one or more fillers selected from the group consisting of aluminum trihydroxide, hydromagnesite, epsomite, nesquihonite, boehmite, huntite, magnesium hydroxides, silicas, ground quartz, alumina, calcium sulfate, copper acetate, magnesium chloride, sodium sulfate, aluminosilicates, boron nitride, aluminum nitride, micas, wollastonite, calcium silicates, basalt, clays, zeolites, hollow glass spheres, hollow ceramics, expanded perlite, calcium carbonate, cerium oxide, iron oxides, titanium oxide, zinc oxide, and glass fibers; and the catalyst is a platinum catalyst.

5. The composition of claim 4 wherein the second polyorganosiloxane further comprises a vinyl-substituted polyorganosiloxane resin.

6. The composition of claim 5 wherein the concentration of the filler, based on the weight of the total composition and the filler, is in the range of from 35 to 55 weight percent; the blowing agent is benzyl alcohol or 1,4-butanediol or a combination thereof; and the filler is a combination of wollastonite and aluminum trihydroxide.

7. The composition of claim 3 wherein the mole-to-mole ratio of D^{H} groups in the first polyorganosiloxane to the ethylenically unsaturated groups in the second polyorganosiloxane is in the range of from 3:1 to 10:1; the blowing agent is benzyl alcohol or 1,4-butanediol or a combination thereof; and the filler is a combination of wollastonite and aluminum trihydroxide; wherein the second polyorganosiloxane comprises a divinylpolymethylsiloxane and a divinylpolymethylsiloxane resin.

8. The composition of claim 6 wherein the mole-to-mole ratio of D^{H} groups in the first polyorganosiloxane to ethylenically unsaturated groups in the second polyorganosiloxane is in the range of from 3:1 to 10:1; the blowing agent is benzyl alcohol or 1,4-butanediol; and the filler is a combination of wollastonite and aluminum trihydroxide.

9. The composition of claim 2 wherein the second polyorganosiloxane is functionalized with one ethylenically unsaturated group and one OH group or functionalized with two OH groups.

10. The composition of claim 1 wherein components a), b), c), and d) react to form a foam with a density in the range of from 0.20 to 0.60 g/cm³.

11. The composition of claim 10 wherein the foam has a density in the range of from 0.25 g/cm³ to 0.52 g/cm³, and a filler concentration in the range of from 35 to 55 weight percent, based on the weight of the foam and the filler.

12. A battery module comprising a shell containing an array of spatially separated battery cells and the composition of claim 1 contacting adjacent battery cells.
